(19) United States
(12) Patent Application Publication
(10) Pub. No.: US 2013/0255633 A1
(43) Pub. Date: Oct. 3, 2013

(54) INTERNAL COMBUSTION ENGINE HAVING COMPRESSION-INDUCED AUTO-IGNITION AND METHOD FOR IGNITING FUEL IN SUCH AN INTERNAL COMBUSTION ENGINE

(71) Applicant: Franz-Josef Hinken, Bad Iburg (DE)

(72) Inventor: Franz-Josef Hinken, Bad Iburg (DE)

(21) Appl. No.: 13/992,262

(22) PCT Filed: Dec. 8, 2011
(86) PCT No.: PCT/DE2011/002090

§ 371 Date: Jun. 7, 2013

(30) Foreign Application Priority Data
Dec. 8, 2010 (DE) 10 2010 054 384.5

(51) Int. Cl. F02M 39/00

(52) U.S. Cl. CPC F02M 39/00
USPC 123/445

(57) ABSTRACT

An internal combustion engine with compression-induced auto-ignition is disclosed. A reciprocating-piston engine includes at least one cylinder (1) in which a piston (2) is connected via a connecting rod to a crankshaft and movable in a reciprocating fashion in the cylinder. A cylinder head (3) is positioned over and encloses the cylinder to define a cylinder chamber (4) in the cylinder (1). The cylinder head (3) also has a compression pipe (6) which opens toward the cylinder chamber (4) and is equipped with at least one injection nozzle (5). A method for igniting fuel in an internal combustion engine is also described in which a fuel jet (7) from the injection nozzle (5) is injected, so as to avoid wetting of the inner wall of the compression pipe (6), when the piston (2) is situated in a position between 20° crank angle and 180° crank angle before top dead center.

The invention relates to an internal combustion engine having compression-induced auto-ignition according to the preamble of patent claim 1 and a method for igniting fuel in such an internal combustion engine.

Even today, the degrees of efficiency of internal combustion engines and the pollutant emission thereof are still unsatisfactory, even though considerable means are used and intensive research is carried out in order to provide a remedy in this regard.

The continually increasing prevalence of internal combustion engines and the increasing registration numbers for motor vehicles have brought about legislation worldwide in order to increasingly reduce the exhaust emissions.

In principle, a distinction is made between two different engine concepts. The Otto engine is characterised by the combustion of a mixture of air and fuel within a turbulent combustion zone, which, initiated by an ignition spark, moves through the mixture.

In diesel engines in contrast, there is formed by means of injection of fluid fuel into highly compressed hot air a non-homogeneous mixture which ignites of its own accord.

In modern engine construction, attempts are directed towards achieving the most homogeneous mixture possible in order to optimise the waste gas and exhaust gas values. One example of this is homogeneous compression ignition (Homogeneous Charge Compression Ignition, HCCI), which refers to a concept for an engine in which the combustion of a homogeneous mixture begins at the same time in the entire cylinder space. The primary objective of this development is the reduction of the emission of pollutants. The ignition is initiated by the temperature which increases during compression and optionally radicals remaining in the cylinder space. In the HCCI engine, however, the charge composition is intended to be as uniform as possible so that the combustion begins at the same time in the entire cylinder space. This particularly applies when diesel fuel is used, but unfortunately still leads to the various unsolved problems of this combustion method. A quite significant disadvantage of the internal combustion engines which are currently used is, for example, that fuel is applied to the wall during the formation of the mixture. This can be attributed to the low pressure conditions (100° KW before top dead centre (TDC)) in the cylinder and the excessively small spacing of the injection nozzle from the piston base and from the cylinder wall and brings about the formation of a non-homogeneous mixture, which leads to uncontrolled auto-ignition. Furthermore, the pollutant emissions increase disproportionately and the fuel consumption increases.

Extensive investigations also take place in order to establish the optimal ignition time or to achieve a control of the ignition time for an optimum degree of efficiency by means of the compression in all charge regions. Unfortunately, however, the results have been unsatisfactory until now since there are often pressure peaks and fluctuations in the cylinder space pressure and high HC and CO emissions are also observed. A specific problem of the HCCI method is the poor cold start and engine idling behaviour. Furthermore, the steep pressure increases and the cylinder space pressure fluctuations in the upper charge range which may be observed owing to the compression-induced auto-ignition are not acceptable.

DE-PS 967752 already discloses an internal combustion engine in the form of a piston engine, in which a piston which is connected to a crankshaft by means of a connecting rod can be moved in translation, a cylinder head forming the upper limit of a cylinder space in the cylinder. The cylinder space is constructed in this embodiment in such a manner that it has a cylinder-head-side extension which is constructed in a conical or paraboloid manner and on the upper side of which facing away from the piston base the injection nozzle is arranged. According to the disclosure of the publication, the fuel is intended to be injected in a conical jet onto the hot base of the piston by means of the injection nozzle towards the end of the compression stroke so that it partially rebounds and is reflected into a turbulence zone produced in the cylinder space. The turbulence zone is achieved by means of recesses in the piston base. The actual ignition of the fuel is carried out in this instance by means of a combination of the heat emitted by the walls of the cylinder head and the piston base and the compression heat of the fuel/air mixture. With such an embodiment, application of the fuel to the wall in order to ignite the fuel is even explicitly necessary; however, this involves the disadvantages already mentioned in the introduction and is therefore intended to be avoided.

Even a conventional precombustion chamber engine, as described, for example, in DE-PS 967752 or in GB 204551 A, has these disadvantages.

An object of the invention is, with an internal combustion engine having compression-induced auto-ignition, to achieve an increase of the degree of efficiency with simultaneous reduction of the pollutant emissions and to provide a method by means of which the fuel can be ignited with the maximum energy yield.

This object is achieved according to the invention with the features of the independent patent claims 1 and 10.

The subsequent dependent claims relate to other embodiments of the invention.

An internal combustion engine having compression-induced auto-ignition, in the form of a piston engine, having at least one cylinder in which a piston which is connected to a crankshaft by means of a connection rod can be moved in translation, a cylinder head forming the upper limit of a cylinder space in the cylinder, has been developed according to the invention in that the cylinder head has a compression pipe which is open in the direction towards the cylinder space and which is provided with at least one injection nozzle.

The compression-induced auto-ignition of a homogeneous fuel/air mixture which takes place according to the invention is carried out almost under identical spatial conditions. It has been found that, with a homogeneous compression-induced auto-ignition, not only can the pollutant emissions be reduced to almost zero, but also the degree of efficiency of the internal combustion engine considerably increases.

It is particularly significant for the mixture of the fuel and air admixture to be carried out in a proportional manner in the cylinder space and in the compression pipe. During the compression stroke, the fuel is partially injected through the compression pipe into the cylinder space without the wall becoming wetted.

In the compression pipe, a significant pressure increase can be seen in the compression phase, which results from the small cross-section surface-area of the compression pipe in relation to the piston surface-area, for which reason the term “pipe” is also used for clarification. However, this also leads to the pressure compensation between the compression pipe and cylinder space (12° before TDC to 12° after TDC) being so slow that the pressure increase in the cylinder space in all charge and speed ranges is very moderate.

In addition, the piston produces in the region of the top dead centre (TDC) a closure effect of the compression pipe so that an accordingly delayed pressure increase is brought about in the cylinder space. The maximum pressure on the piston is always reached only after TDC.

Other advantages of the invention are that a demonstrable reduction of the HC and CO emissions can be achieved. With a controlled injection operation, it can additionally be brought about that no accumulation of fuel/air mixture in the cylinder space may be observed in the region of the web and the valve spaces.

A first embodiment of the invention consists in that the cross-section surface-area of the compression pipe is from 4% to 10% of the piston surface-area. That is to say, it is significant that the cross-section surface-area of the compression pipe is kept as small as possible in relation to the piston surface-area. This measure contributes significantly to the success according to the invention since the pressure wave which is produced when the fuel/air mixture is ignited strikes less than a tenth of the original piston surface-area.

It has further been found that a length/diameter relationship of the compression pipe of between 2 and 6 has very advantageous effects on the progression of the injection, the compression and the expansion of the pressure wave after the ignition of the fuel/air mixture.

Accordingly, the compression pipe, according to this further notion of the invention is generally intended where possible to have a greater length than the value of the width or the diameter thereof, that is to say, is intended to be constructed in a long and narrow manner.

In order to prevent application of the fuel jet to the piston base, it is further proposed that the injection nozzle be arranged in the upper end of the compression pipe facing away from the cylinder space. For example, in an internal combustion engine which has already been tested in trials, the injection nozzle was arranged from 4 to 8 cm away from the cylinder space in the compression pipe, which led to a combustion which has an extremely low level of pollutants and which saves fuel.

A particularly preferred development of the invention further makes provision for the compression pipe to be constructed as a tubular member having a circular-cylindrical, inner covering face. The circular-cylindrical shape of the compression pipe has the advantage that, during the injection operation, less air is taken from the fuel jet. Consequently, in the upper portion of the compression pipe having the injection nozzle, a richer admixture is formed which significantly promotes the ignition operation in the compression pipe. Furthermore, it is possible to provide the compression pipe with a slightly conical or parabolic geometry.

The simple configuration of an internal combustion engine according to the invention and in particular the compression pipe not only enables new engines to be provided with a device according to the invention but also the retrofitting of units which are already in use. For these purposes, a proposal according to the invention is to configure the compression pipe with the injection nozzle arranged therein as a retrofittable structural unit.

In order to avoid a wetting of the wall faces of the cylinder space with fuel and consequently an increase of the fuel consumption, and to prevent the resultant negative influence on the exhaust gas emissions, an embodiment of the invention makes provision for the piston to have a planar piston base.

A planar piston base prevents uncontrollable occurrences of turbulence in the cylinder space, as produced by means of recesses in the piston base, because these occurrences of turbulence according to experience lead to the fuel/air admixture which develops being distributed in all the regions of the cylinder space and also striking the walls. In addition, the piston is simpler to produce and consequently more cost-effective.

An alternative to this is for the compression pipe to be constructed in two portions, and for a first portion of the compression pipe to be arranged in the cylinder head and the second portion of the compression pipe to be produced in the piston base of the piston. In this instance, the piston base is consequently provided with a recess which forms the second portion of the compression pipe. This particular construction variant of the invention leads to a very compact construction of the engine cylinder.

In particular for the processing of diesel fuel, it is advantageous for the compression pipe to have a preheating system. The heating of the compression pipe may, however, also have a positive effect on the combustion process of an Otto engine. In any case, the cold starting properties of the internal combustion engine are significantly improved by this measure.

In the method according to the invention for igniting fuel in an internal combustion engine, a fuel jet is injected via the injection nozzle whilst preventing the inner wall of the compression pipe from becoming wet when the piston is located in a position between 20° KW and 180° KW before TDC.

The solution to the problem set out in the introduction is to achieve very early introduction of the fluid fuel in the compression stroke so that there remains sufficient time for a complete evaporation and mixture of the fuel with the air provided in the cylinder space and optimal homogenisation of the fuel/air mixture is carried out. This method can be used for the internal combustion engines which are known today.

The specific features in the combustion of diesel fuel lead to a specific embodiment of this method being that the fuel jet is injected in this instance when the piston is located in a position between 20° KW and 60° KW before TDC. In this range, optimal results were achieved.

The specific feature of introducing the fuel into the compression pipe can be seen in the injection nozzle producing a high-pressure thin, tapered fuel jet which is directed in the direction towards the cylinder space and which has a small dispersion. It is thereby possible to prevent the wall from becoming wetted with fuel. Nowadays, pressures of more than 1000 bar can be produced via the injection nozzle and are accordingly conventional. The orientation of the fuel jet may be controlled by means of the structural configuration of the injection nozzle. For instance, single-jet injection nozzles are particularly advantageous in this instance.

The further implementation of the method according to the invention is configured in such a manner that the injection of the fuel is carried out during the compression stroke of the piston and subsequently the entire compression volume of the fuel/air mixture which is produced therewith is pressed into the compression pipe. It is thereby possible to cause the auto-ignition and combustion of the fuel/air mixture and an associated steep pressure increase to be produced in the compression pipe whilst the piston is located at the TDC or shortly after TDC.

Since the piston more or less closes the output of the compression pipe in the range between 12° before TDC to 12° after TDC, the compression ignition and the energy conversion take place completely in the compression pipe, which is the subject-matter of the invention. The compression ignition of the fuel/air mixture may take place in the range from 15° before TDC to 15° after TDC. Fluctuations from cycle to cycle have no negative influences on the running behaviour of the engine.

Another measure is that, in the case of internal and/or external mixture formation, the compression-induced auto-ignition is initiated in a controlled manner by means of positive ignition in the compression pipe. The positive ignition of the homogeneous fuel/air mixture brings about in a controlled manner, by means of the flame front and the associated temperature and pressure increase in the compression pipe, a compression-induced auto-ignition of the remaining homogeneous mixture.

As a particular feature, it should also be considered that, during idle operation of the internal combustion engine, a stratified charge may be carried out in the upper portion of the compression pipe.

In order to improve the cold-starting behaviour, it is further proposed that a cold start of the internal combustion engine be carried out in a manner known per se using a glow plug/spark plug.

A particular advantage of the method according to the invention is also that a block type and/or multiple injection system can be used.

In the case of high-octane fuels and fuels which are difficult to ignite, the external mixture formation can also be used, the fuel/air mixture also being pressed by the piston into the compression pipe and, depending on the charge and fuel/air ratio, being able to be ignited in the upper portion of the compression pipe in a compression-induced manner or by means of positive ignition.

The invention is explained in greater detail below with reference to the appended drawings. The embodiments shown do not constitute a limitation with respect to the illustrated variants, but instead serve only to explain a principle of the invention. Components which are the same or similar are given the same reference numerals. In order to be able to illustrate the operating method according to the invention, only greatly simplified schematic drawings are shown in the Figures, in which components which are not significant for the invention have been omitted. However, this does not mean that such components are not present in a solution according to the invention. In the drawings:

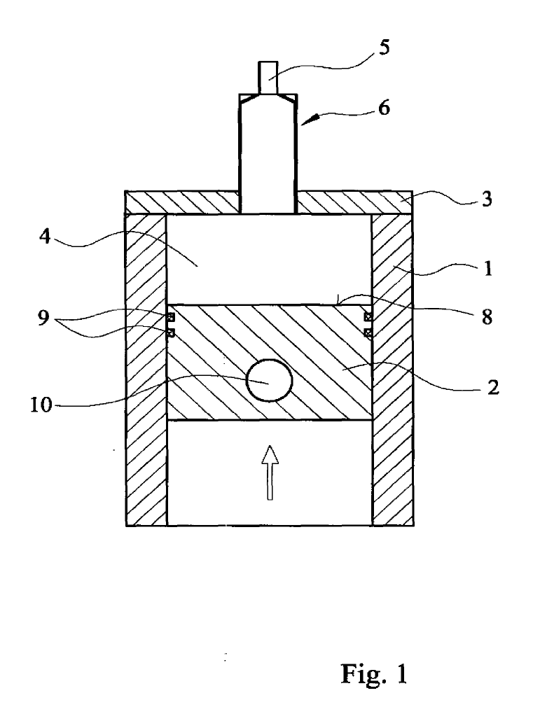

FIG. 1 is a highly simplified schematic cross-section through a cylinder of a first embodiment of an internal combustion engine during the compression stroke,

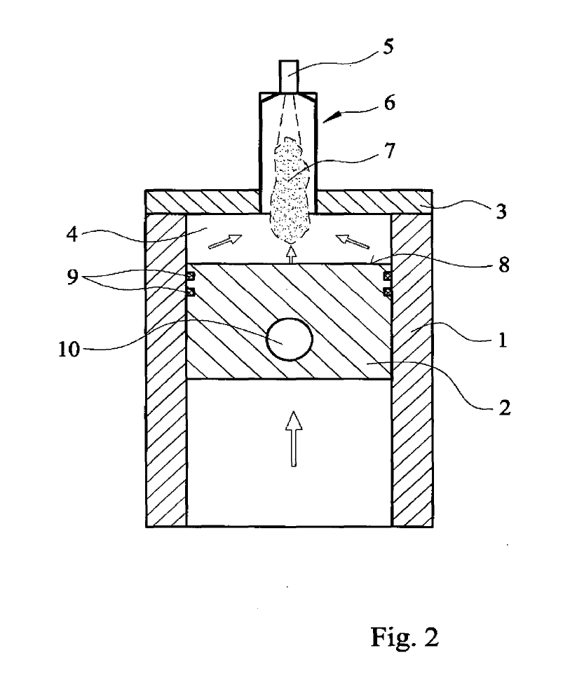

FIG. 2 is a sectioned view according to FIG. 1, with increasing compression and a piston position which has been changed thereby,

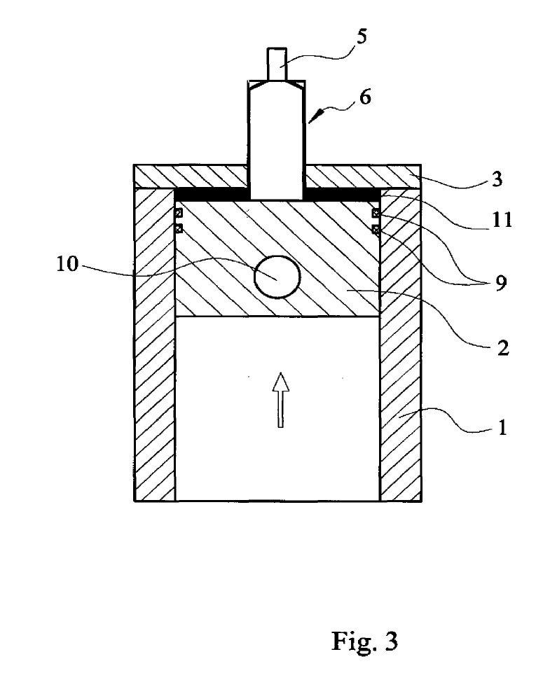

FIG. 3 is a sectioned view through a cylinder, in which the piston is shortly before the top dead centre,

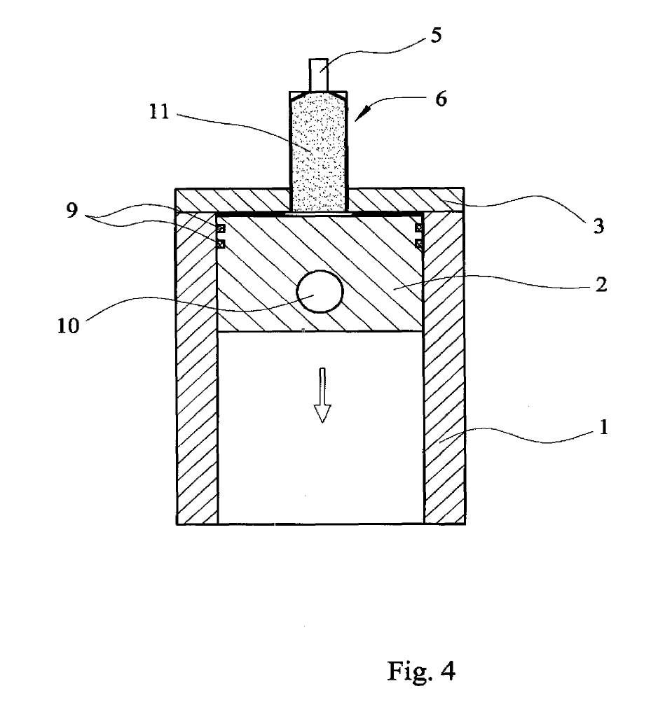

FIG. 4 is a sectioned view with the piston at the top dead centre,

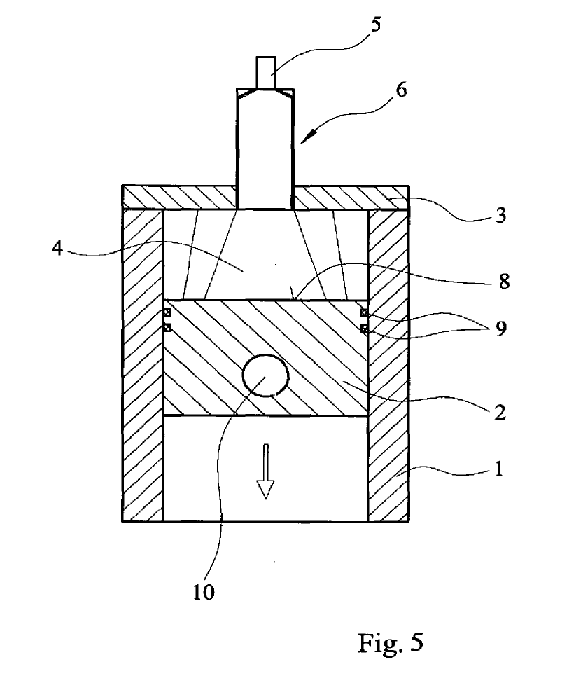

FIG. 5 is a sectioned view of a cylinder with a position of the piston during the expansion stroke, and

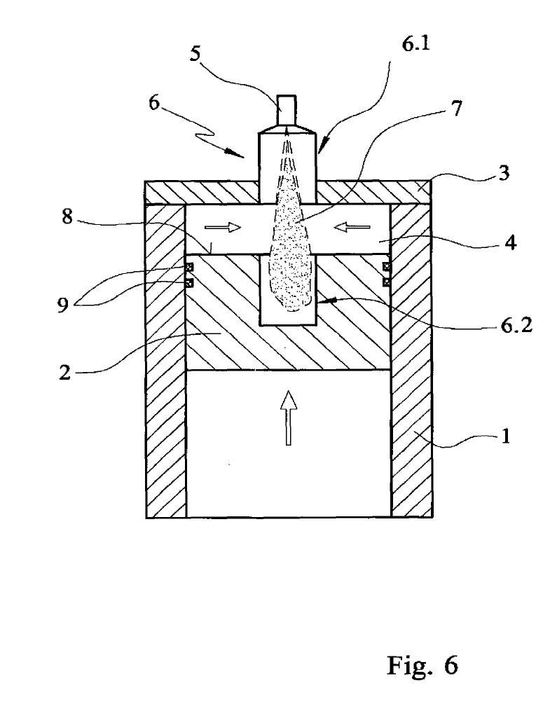

FIG. 6 is another construction variant of an internal combustion engine with a two-part compression pipe.

FIGS. 1-5 illustrate various stages of an internal combustion operation inside a cylinder 1 of an internal combustion engine. First, FIG. 1 is a schematically highly simplified cross-section through a cylinder 1 of an internal combustion engine during the compression stroke of the piston 2 which can be moved in translation in the cylinder 1 in a first position. The piston 2 has a connecting rod bearing 10, which provides the connection with respect to a connecting rod which is not illustrated here for reasons of simplicity and which in turn converts the translation movement of the piston into a rotation of the crankshaft of the internal combustion engine. In the region of the piston base 8, the piston 2 has a plurality of piston rings 9, which serve to seal the cylinder space 4 in the cylinder 1. The upper closure of the cylinder 1 is formed by a cylinder head 3 which has a compression pipe 6 as a specific feature according to the invention. At the upper end of the compression pipe 6 opposite the cylinder space 4, an injection nozzle 5 is inserted into the compression pipe 6 and serves to inject the fuel. It is particularly significant in this instance that the compression pipe 6 has a circular-cylindrical geometry, the length of the compression pipe 6 being substantially greater than the diameter thereof.

In FIG. 2, in comparison with the illustration in FIG. 1, the piston 2 has moved further in the direction of the top dead centre. During this movement, the air enclosed in the cylinder space 4 is compressed and a fuel jet 7 is introduced via the injection nozzle 5. The geometry of the fuel jet 7 prevents application to the wall in the compression pipe 6, to the cylinder inner wall and the piston base 8. The fuel jet 7 extends in a tapered manner and is injected at high pressure. The fuel jet 7 is mixed with the air present in the cylinder space 4 partially in the compression pipe 6 and partially in the cylinder space 4.

In the illustration in FIG. 3, the piston 2 has moved slightly further in the direction of the top dead centre. Owing to this movement, the fuel/air mixture 11 is transported into the compression pipe 6, in which the entire volume of the fuel/air mixture 11 is now in compressed form. The progression of the injection is controlled in such a manner that there is no longer an accumulation of the fuel/air mixture 11 in the cylinder space 4. Such an accumulation would lead to increased formation of HC and CO emissions which is, however, intended to be prevented and can be prevented by the solution according to the invention.

In the following step, which is shown in FIG. 4, the piston 2 almost completely closes the outlet of the compression pipe 6 which is open in the direction towards the cylinder space 4, which is carried out substantially between 10° before TDC and 10° after TDC. With the further increasing temperature of the fuel/air mixture 11 during the compression stroke, shortly before TDC or shortly after TDC the compression-induced auto-ignition is carried out within the compression pipe 6, in which the entire energy conversion also takes place equally. The compression ignition is carried out in the range of the piston position between 12° before TDC and 12° after TDC. The very short burning time of the fuel/air mixture 11 and the resultant very steep pressure increase including the cylinder space pressure fluctuations which occur take place in the compression pipe 6 and consequently remain enclosed in the compression pipe 6 or are compensated for.

Since the cross-section surface-area of the compression pipe 6 is only from 4 to 10% of the piston surface-area, the pressure wave which is produced strikes less than 1/10 of the piston surface-area. The maximum pressure on the piston 2 is always applied after the top dead centre (TDC) so that maximum power yield is possible at that location.

As can be seen in the illustration in FIG. 5, following the operations described above, the piston 2 moves during its expansion stroke downwards in the direction of the lower dead centre and drives the camshaft, whilst the combustion residues formed are discharged.

Another construction variant of an internal combustion engine according to the invention can be seen in the illustration in FIG. 6. The cylinder 1 and the cylinder head 3 are structurally identical to the previously described construction variant. The piston 2 is shown in this instance during the compression stroke, that is to say, during its movement in the direction TDC. In this solution, there is also a compression pipe 6 present, but which comprises in this instance two portions 6.1 and 6.2. A first portion 6.1 of the compression pipe 6 was arranged in the cylinder head 3 and the second portion 6.2 precisely opposite the first portion 6.1 in the piston base 8. Such a measure prevents in an improved manner an undesirable wetting of the wall of the cylinder space 4 with fuel since the fuel jet 7 is introduced directly into the second portion 6.2 of the compression pipe 6.

### LIST OF REFERENCE NUMERALS

1 Cylinder
2 Piston
3 Cylinder head
4 Cylinder space
5 Injection nozzle
6 Compression pipe
6.1 First portion of the compression pipe
6.2 Second portion of the compression pipe
7 Fuel jet
8 Piston base
9 Piston rings
10 Connection rod bearing
11 Fuel/air mixture

1-18. (canceled)

19. An internal combustion engine having compression-induced auto-ignition comprising:
an engine block having at least one cylinder;
a piston connected to a crankshaft by means of a connection rod, said piston moveable in reciprocating motion in the cylinder; and
a cylinder head positioned on top of the engine block to enclose the cylinder and define a cylinder space, the cylinder head having a compression pipe which is open in the direction towards the cylinder space and which is provided with at least one injection nozzle.

20. The internal combustion engine according to claim 19, wherein a cross-section area of the compression pipe is from 4% to 10% of a surface area of the piston.

21. The internal combustion engine according to claim 19, wherein the length-to-diameter ratio of the compression pipe is between 2 and 6.

22. The internal combustion engine according to claim 19, wherein the injection nozzle is arranged in an upper end of the compression pipe facing away from the cylinder space.

23. The internal combustion engine according to claim 19, wherein the compression pipe is tubular and has a inner covering face, wherein the geometry of the inner covering face is selected from the group consisting of circular-cylindrical, conical or paraboloid.

24. The internal combustion engine according to claim 19, wherein the compression pipe is constructed with the injection nozzle as a retrofittable structural unit.

25. The internal combustion engine according to claim 19, wherein the piston has a planar piston base.

26. The internal combustion engine according to claim 19, wherein the compression pipe further comprises a first portion arranged in the cylinder head and a second portion arranged in a piston base of the piston.

27. The internal combustion engine according to claim 19, wherein the compression pipe further comprises a preheating system.

28. A method for igniting fuel in the internal combustion engine of claim 19, wherein a fuel jet is injected via the injection nozzle whilst preventing the inner wall of the compression pipe from becoming wet when the piston is located in a position between 20° KW and 180° KW before top dead center.

29. The method according to claim 28, wherein a fuel jet is injected when the piston is located in a position between 20° KW and 60° KW before top dead center when diesel fuel is used.

30. The method according to claim 28, wherein the injection nozzle produces a high-pressure thin, tapered fuel jet which is directed in the direction towards the cylinder space and which has a small dispersion.

31. The method according to claim 28, wherein injection of the fuel is carried out during the compression stroke of the piston and subsequently the entire compression volume of the fuel/air mixture which is produced therewith is pressed into the compression pipe.

32. The method according to claim 28, wherein auto-ignition and combustion of an fuel/air mixture and an associated steep pressure increase are produced in the compression pipe, whilst the piston is located at a position which is top dead center or shortly thereafter.

33. The method according to claim 28, wherein the compression-induced auto-ignition is initiated in a controlled manner by means of positive ignition in the compression pipe.

34. The method according to claim 33, wherein a cold start of the internal combustion engine is carried out using an ignition plug.

35. The method according to claim 28, wherein a block type injection system is used.

36. The method according to claim 28, wherein a multiple injection system is used.

37. The method according to claim 28, wherein during idle operation of the internal combustion engine, a stratified charge is carried out in an upper portion of the compression pipe.
